(19) United States
(12) Patent Application Publication
(10) Pub. No.: US 2014/0125119 A1
(43) Pub. Date: May 8, 2014

(54) ANNULAR INNER CORE OF ROBBER TRACK, TRACK CHAINS AND CHAIN-DRIVEN VEHICLES

(71) Applicant: Global Track (Yangzhou) Co., Ltd., Yanzhou (CN)

(72) Inventor: Weixing MIN, Kaleen (AU)

(73) Assignee: Global Track (Yangzhou) Co., Ltd., Yanzhou (CN)

(21) Appl. No.: 14/071,859

(22) Filed: Nov. 5, 2013

(30) Foreign Application Priority Data
Nov. 5, 2012 (CN) 201210434169.9

(51) Int. Cl. B62D 55/24

(52) U.S. Cl. CPC B62D 55/24
USPC 305/173; 305/171

(57) ABSTRACT

The invention describes a track chain for diggers, bulldozers, loading vehicles, crawlers, agricultural machines, transport vehicles and the like, a chain link and a chain-driven vehicle with new and useful features concerning the special design of the track chain. The track chain can transfer the driving force well-proportioned, so that it can prevent the rubber track from running off the rails or lateral dislocation.

### THE FIELD OF THE PRODUCTION TECHNOLOGY

This invention involves in the driving technology of the construction machinery operation, especially for the field of the production technology of rubber tracks for the construction machinery.

The invention also involves track chains and chain-driven vehicles like crawlers or the like.

### BACKGROUND OF TECHNOLOGY

The rubber track is made up of the rubber, steel wires and the annular inner core. The annular inner cores are made up of a lot of iron cores, the adjacent iron cores are mutual engagement and become a chain annular inner core. The iron cores are distributed on the length direction of the rubber track and transverse parallel in the rubber track.

As is well known, the annular inner cores are the main part of a rubber track, the adjacent iron cores are mutual engagement and become a steady skeleton of a rubber track. It can protect the drive device, slave unit and the branched counterweight for the construction machinery to make the rubber track work smoothly on the walking device.

In order to reduce the production costing, people designs the same iron core for a rubber track, the structure of the adjacent iron cores is identical. This will cause the rubber track run off the rail or lateral dislocation when the rubber track works on the construction machinery. It will affect the normal working of the construction machinery.

### CONTENT OF THIS INVENTION

This invention is to design an annular inner core of rubber track to make the rubber tracks work on the walking equipment stably.

This invention is including the interval first iron core and second iron core.

The first iron core is including the first interface with the driving wheels, there are the first left wing and the first right wing on the both sides of the first interface with the driving wheels. There is the first left top of the iron core between the first left wing and the first interface with the driving wheels and the first right top of the iron core between the first right wing and the first interface with the driving wheels. The first left and right tops of the iron core are doming with the same side of the first interface with the driving wheels.

The second iron core is including the second interface with the driving wheels, there are the second left wing and the second right wing on the both sides of the second interface with the driving wheels. There is the second left top of the iron core between the second left wing and the second interface with the driving wheels and the second right top of the iron core between the second right wing and the second interface with the driving wheels. The second left and right tops of the iron core are doming with the same side of the second interface with the driving wheels.

The characteristics are:

There are the first left fork-type buckles on the both sides of the first interface with the driving wheels and perpendicular to the doming direction of the first left top of the iron core.

There are the first right fork-type buckles on the both sides of the first interface with the driving wheels and perpendicular to the doming direction of the first right top of the iron core.

There are the second left pointed snaps on the both sides of the second interface with the driving wheels and perpendicular to the doming direction of the second left top of the iron core.

There are the second right pointed snaps on the both sides of the second interface with the driving wheels and perpendicular to the doming direction of the second right top of the iron core.

The first left fork-type buckle and the second pointed snap of the first iron core and the second iron core that are arranged by a certain pitch are mutual engagement. The first right fork-type and the second right pointed snap are mutual engagement.

The iron cores of this invention are mutual engagement with the symmetrical fork-type buckles and the pointed snaps, this can increase the connection stability of the annular inner core, increase the holistic strength in the rubber track. It can transfer the driving force well proportioned, steady so that it can prevent the rubber track from running off the rails or lateral dislocation. It can also avoid the wear and tear between the rubber track and the road wheels, reduce the vibration and bump of the machines, increase the comfort level of the road wheels and it is propitious to increase the service lifetime of the road wheels and the rubber tracks.

Moreover, in this invention there are the arc outer contour surfaces under the first left wing and first right wing.

There are the arc outer contour surfaces under the second left wing and the second right wing.

It can be seen from the forgoing description that the invention is a special anti detracking system in iron teeth design. This system is totally different from prior art. One iron tooth has a recess wing and the other has embossment wing, both can overlap. We make a proedge design on iron teeth. The two ends of iron teeth are made cambered. This new technology can protect rubber track from being cut by sharp edge when rubber track is driven on hard sharp road. So there are two important points, which maybe named “interlock” and “anti-trimming”.

The invention is characterized by the annular inner core of rubber track including the compartmental iron cores, the first iron core and the second iron core, the first iron core is including the first interface with the driving wheels, there are the first left wing and the first right wing on the both sides of the first interface with the driving wheels, there is the first left top of the iron core between the first left wing and the first interface with the driving wheels and the first right top of the iron core between the first right wing and the first interface with the driving wheels, the first left and right tops of the iron core are doming with the same side of the first interface with the driving wheels, the second iron core is including the second interface with the driving wheels, there are the second left wing and the second right wing on the both sides of the second interface with the driving wheels, there is the second left top of the iron core between the second left wing and the second interface with the driving wheels and the second right top of the iron core between the second right wing and the second interface with the driving wheels, the second left and right tops of the iron core are doming with the same side of the second interface with the driving wheels, characterized in that the first left fork-type buckles are on the both sides of the first interface with the driving wheels and perpendicular to the doming direction of the first left top of the iron core, there are the first right fork-type buckles on the both sides of the first interface with the driving wheels and perpendicular to the doming direction of the first right top of the iron core, there are the second left pointed snaps on the both sides of the second interface with the driving wheels and perpendicular to the doming direction of the second left top of the iron core, there are the second right pointed snaps on the both sides of the second interface with the driving wheels and perpendicular to the doming direction of the second right top of the iron core, the first left fork-type buckle and the second pointed snap of the first iron core and the second iron core that are arranged by a certain pitch are mutual engagement, the first right fork-type and the second right pointed snap are mutual engagement.

The invention is also characterized by a track chain in that the annular inner core of rubber track is that there are the arc outer contour surfaces under the first left wing and the first right wing.

The invention is also characterized by a track chain in that the annular inner core of rubber track is that there are the arc outer contour surfaces under the second left wing and the second right wing.

The invention is also characterized by a track chain for chain-driven vehicles such as construction vehicles (diggers, bulldozers, loading vehicles, etc.), agricultural machines (seeding and harvesting machines, etc.), transport vehicles (snowmobiles, snowcats, tracklaying vehicles, etc.), where the track chain consists of chain links made of a steel alloy and disposed a distance apart in the direction of travel and which on their surfaces coming into contact with the ground to be driven over are embedded either singly or preferably in pairs in a matrix made from elastic plastic or natural rubber (NR) or tyrene-butadiene rubber (SBR), where two adjacent chain links are at right angles to the direction of travel provided with elements set a distance apart and point in the direction of travel and mesh moveably with one another in a plane which lies perpendicular to the direction of travel.

Another solution would be a track chain for chain-driven vehicles such as construction vehicles (diggers, bulldozers, loading vehicles, etc.), agricultural machines (seeding and harvesting machines, etc.), transport vehicles (snowmobiles, snowcats, tracklaying vehicles, etc.), where the track chain consists of chain links made of a steel alloy and disposed a distance apart in the direction of travel and which by their surfaces which come into contact with the ground to be driven over are embedded either singly or preferably in pairs in a matrix made from elastic plastic or natural rubber (NR) or tyrene-butadiene rubber (SBR), where two adjacent chain links are provided with projecting portions which are set a distance apart and point in the direction of travel and which incorporate recesses and the one, adjacent chain link is provided with projecting portions which are set a distance apart and pointing towards the other chain link in the direction of movement of the track chain and engage positively and moveably with clearance with the recesses in the other adjacent chain link.

Another solution would be a track chain for chain-driven vehicles such as construction vehicles (diggers, bulldozers, loading vehicles, etc.), agricultural machines (seeding and harvesting machines, etc.), transport vehicles (snowmobiles, snowcats, tracklaying vehicles, etc.), where the track chain consists of chain links made of a steel alloy and disposed a distance apart in the direction of travel and which by their surfaces which come into contact with the ground to be driven over are embedded either singly or in pairs in a matrix made from elastic plastic or natural rubber (NR) or tyrene-butadiene rubber (SBR), where at right angles to the direction of movement of the respective chain one of two adjacent chain links made from steel is provided with projecting portions which are set a distance apart and point in the direction of movement of the chain and incorporate recesses and the other, adjacent chain link is provided with projecting portions which are set a distance apart and project against the other chain link in the direction of movement of the track chain and engage positively but with clearance with the recesses in the one adjacent chain link, where the recesses and the projecting portions which engage in them are in plan view enclosed by straight side faces.

Another solution would be a track chain for chain-driven vehicles such as construction vehicles (diggers, bulldozers, loading vehicles, etc.), agricultural machines (seeding and harvesting machines, etc.), transport vehicles (snowmobiles, snowcats, tracklaying vehicles, etc.), where the track chain consists of chain links made of a steel alloy and disposed a distance apart in the direction of travel and which by their surfaces coming into contact with the ground to be driven over are embedded either singly or in pairs in a matrix made from elastic plastic or natural rubber (NR) or tyrene-butadiene rubber (SBR), where at right angles to the direction of travel two adjacent chain links incorporate projecting portions with recesses, and the other chain link incorporates projecting portions which engage with the recesses and the projecting portions which engage with the recesses and the recesses in the chain links made from steel are trapezium-shaped.

Another solution would be a track chain for chain-driven vehicles such as construction vehicles (diggers, bulldozers, loading vehicles, etc.), agricultural machines (seeding and harvesting machines, etc.), transport vehicles (snowmobiles, snowcats, tracklaying vehicles, etc.), where the track chain consists of chain links made of a steel alloy and disposed a distance apart in the direction of travel and which by their surfaces coming into contact with the ground to be driven over are embedded either singly or in pairs in a matrix made from elastic plastic or natural rubber (NR) or tyrene-butadiene rubber (SBR), where at right angles to the direction of movement of the respective chain two adjacent chain links are provided with projecting portions with recesses and projecting portions which engage with the recesses, where the recesses and the projecting portions which engage with the recesses are formed triangular in the plan view and the edge areas are rounded off. The track chain is characterized in that the flank angle of the projecting portions and recesses in the chain links which respectively engage with one another is acute-angled and which is not a self-locking angle.

The track chain is characterized in that the side faces of the projecting portions and of the two recesses of the steel chain links which lie against each one are formed curved and roll over each other when the track chain moves.

The track chain is characterized in that the matrix which is made of plastic is made of an elastomer plastic which is resistant to water, oil and petrol which are encountered in practical operation and is also designed to be ozone-resistant and light-fast.

The track chain is characterized in that the matrix which is made of plastic is made of a natural rubber (NR) or a styrene-butadiene rubber (SBR) having the required Shore hardness and resilience and is stable at a temperature of from minus 50° C. to plus 70° C., when it is made of NR or minus 40° C. to plus 80° C. if it is made of SBR.

The track chain is characterized in that the matrix which is made of plastic is made of polyurethane plastic or polyamide plastic 4 having the required Shore hardness and resilience.

The track chain is characterized in that the matrix which is made of plastic is reinforced with wires which are made preferably of steel and completely enclosed in plastic and are set a distance apart and extend in the direction of travel of the chain.

The track chain is characterized in that the matrix also encloses the chain links which are made of steel at their sides.

The track chain is characterized in that between the projecting portions and the recesses on adjacent chain links which engage with one other a gap is disposed with which each of the teeth of any motor-driven gear wheels used on the respective track-laying vehicle engage.

The track chain is characterized in that the chain links which are made of steel are provided with single-piece projecting portions disposed at their end portions and arranged at right angles to them which projecting portions engage in the plastic matrix and connect the matrix to the respective chain link in a single piece.

The track chain is characterized in that the chain links are made of a steel having the following physical properties: a bending strength F≧35 KN.

The track chain is characterized in that the chain links which are made of steel are manufactured in a single piece by drop-forging.

The track chain is characterized in that the chain links made of steel are manufactured in a single piece by the cast steel method.

The track chain is characterized in that the chain links which are made of steel are provided on their side pointing towards the respective gear wheel over which they are guided, with projecting portions which are formed materially in a single piece and which are set a distance part and on each of which projecting portions offset 90 degrees and pointing in the direction of travel and incorporating recesses or projecting portions are provided.

The track chain is characterized in that the projecting portions receiving the teeth of the gear wheel between them are provided on their outer side with ribs which are formed materially in single piece and decrease in height at a constant angle to the end of the respective chain link into the free portions of the respective chain link made of steel and taper down to about the surface of the respective steel chain link.

The track chain is characterized in that several, preferably two chain links which are arranged close to each other are reinforced by steel wires which are positioned side-by-side symmetrically to both sides of the chain link and which are embedded in the matrix made of an elastomere, whereby the steel wires are arranged on the outer side of the chain link which is faced to the floor and whereby the longitudinal axes of the steel wires are parallel to the movement of the track chain.

The chain link for construction of a track chain for chain-driven vehicles is characterized in that the chain link consists of a flat member which is rectangular in plan view and on which in the direction of movement of the chain projecting portions are disposed on both sides of the longer sides of the chain link each of which projecting portions incorporates open recesses or projecting portions facing in the direction of movement of the chain.

The chain link is characterized in that the chain link consists of a flat element which is rectangular in plan view and on which in the direction of movement of the chain, that is, on diametrically opposed sides of the longer sides of the chain link, are disposed projecting portions each of which incorporates recesses which are open in the direction of movement of the track.

The chain link is characterized in that in plan view the one chain link incorporates a rectangular element in the middle longitudinal section of which two material accumulations are provided which are set a distance apart and each of which incorporates on opposite sides and in pairs two projecting portions which project at right angles to each longer side of the respective chain link and are set a distance apart and which between them enclose a preferably trapezium-shaped space, where in plan view the projecting portions are themselves approximately trapezium-shaped, and that material accumulations are provided offset 90 degrees from these projecting portions disposed in pairs a distance apart on each longer side of the chain link each of which material accumulations consists of two parts which are in plan view approximately rectangular and point towards each other by their longer base sides and the edge portions of which are beveled.

The chain link is characterized in that in plan view the other chain link is rectangular-shaped and incorporates in the middle longitudinal portion two material accumulations which are set a distance apart and which consist in plan view of two approximately trapezium-shaped portions which are formed materially in a single piece and which point towards each other and the upper edge areas of which are broken or rounded, where projecting portions offset 90 degrees from these material accumulations are provided on each longer side of the respective chain link and form a single piece with the chain link and in plan view are approximately trapezium-shaped.

The chain-driven vehicles such as construction vehicles (diggers, crawlers, bulldozers, loading vehicles, etc.), agricultural machines (seeding and harvesting machines, etc.), transport vehicles (snowmobiles, snowcats, tracklaying vehicles, etc.) with tracks are driven via gear wheels.

Examples of the invention are shown in the accompanying drawings, partly schematically, in which are:

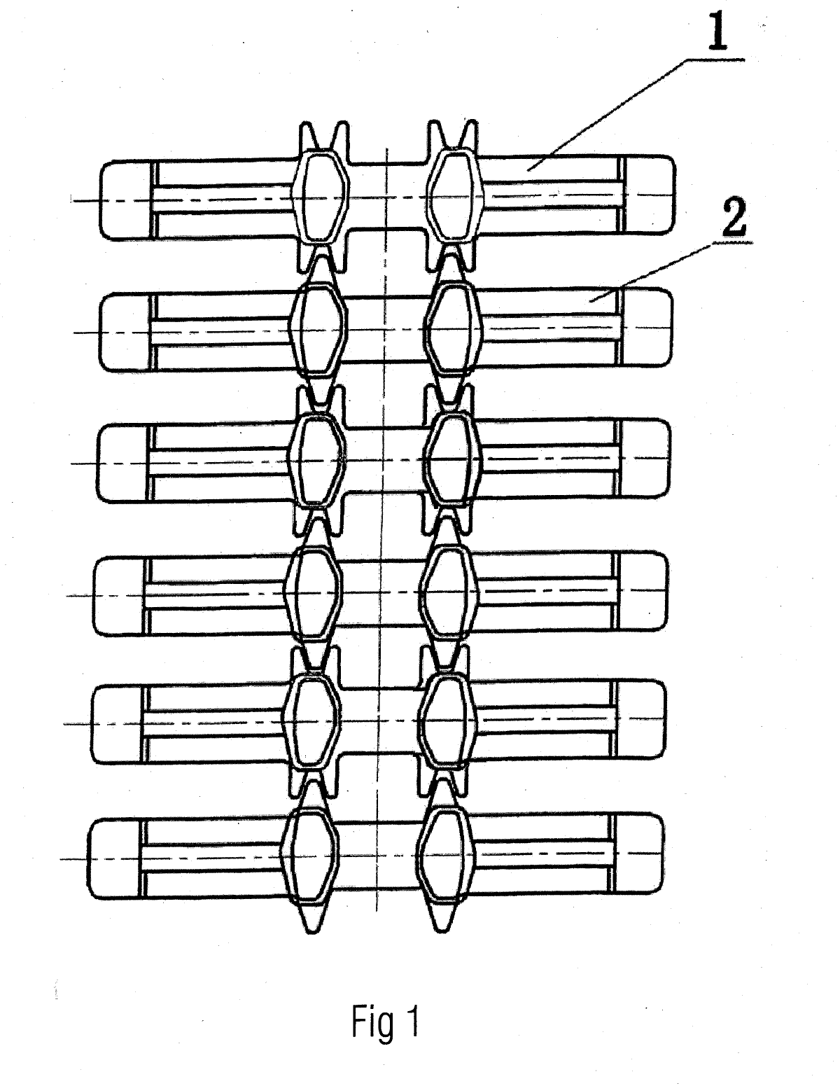

FIG. 1 is the structural representation of this invention;

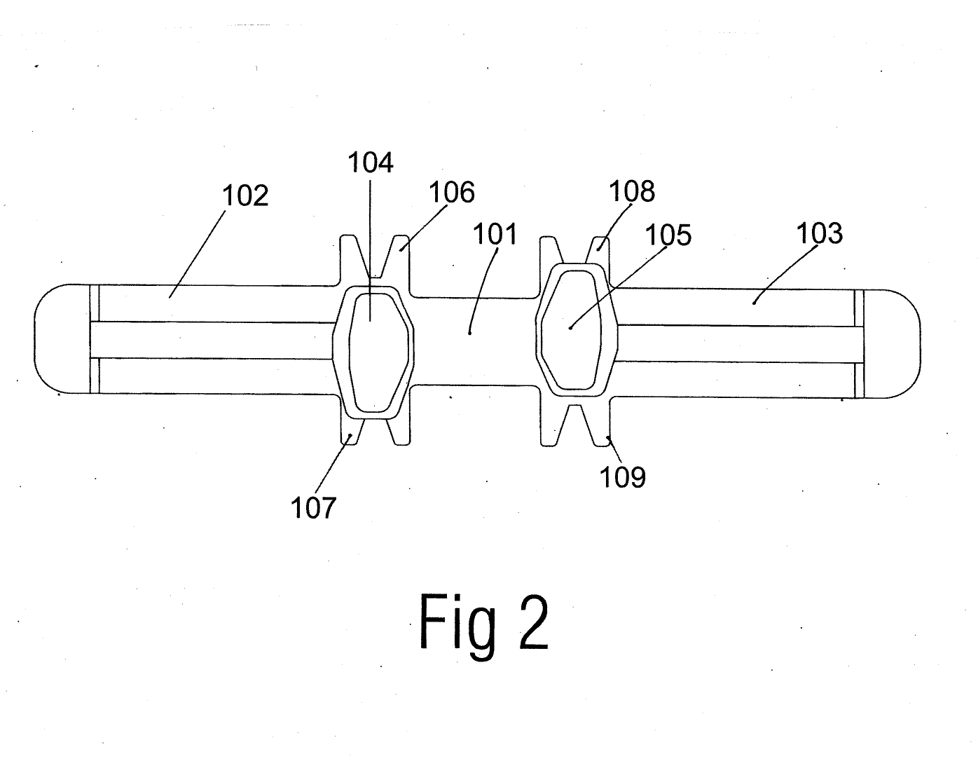

FIG. 2 is the structural representation of the first iron core;

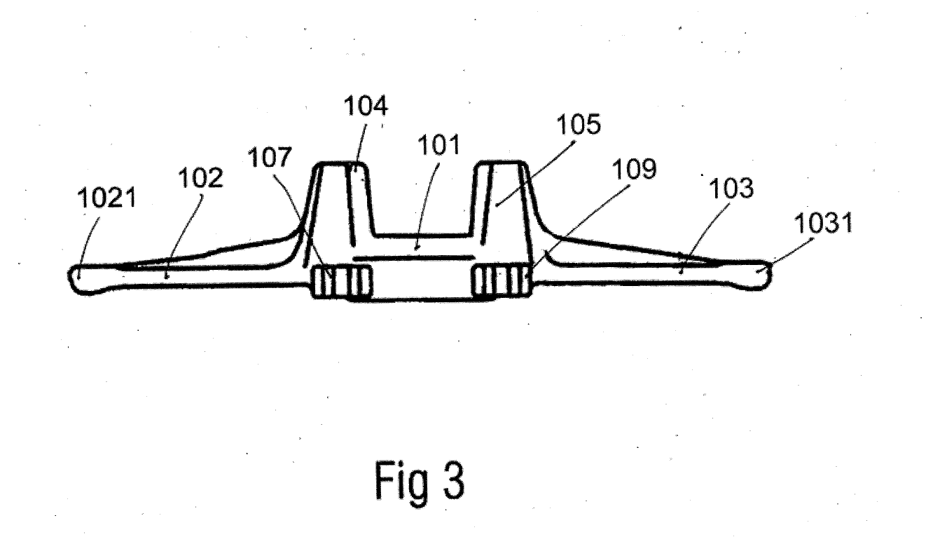

FIG. 3 is the upward view of the drawing 2;

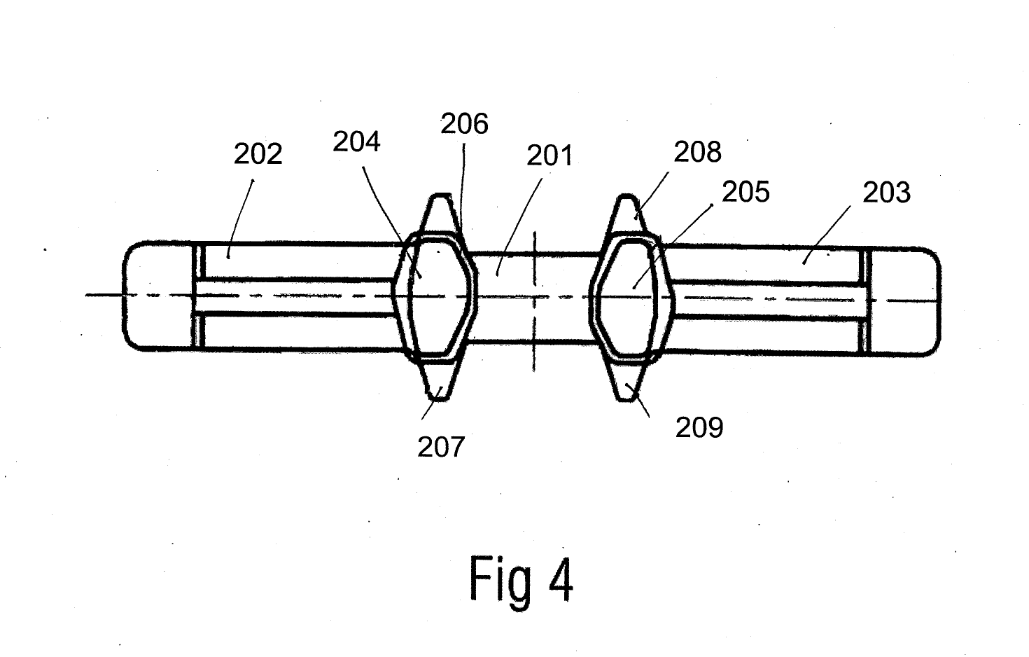

FIG. 4 is the structural representation of the second core;

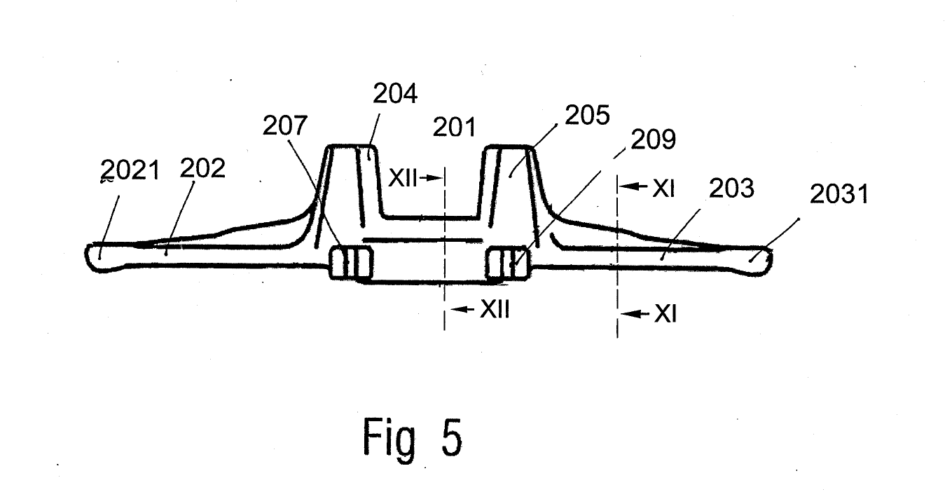

FIG. 5 is the upward view of drawing 4;

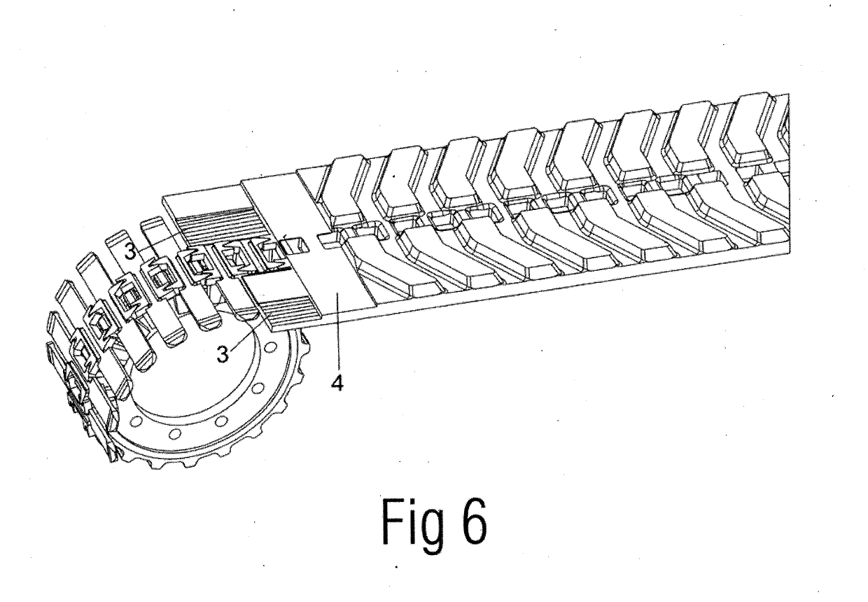

FIG. 6 a track chain with one sprocket of a chain-driven vehicle in perspective view, partly broken away;

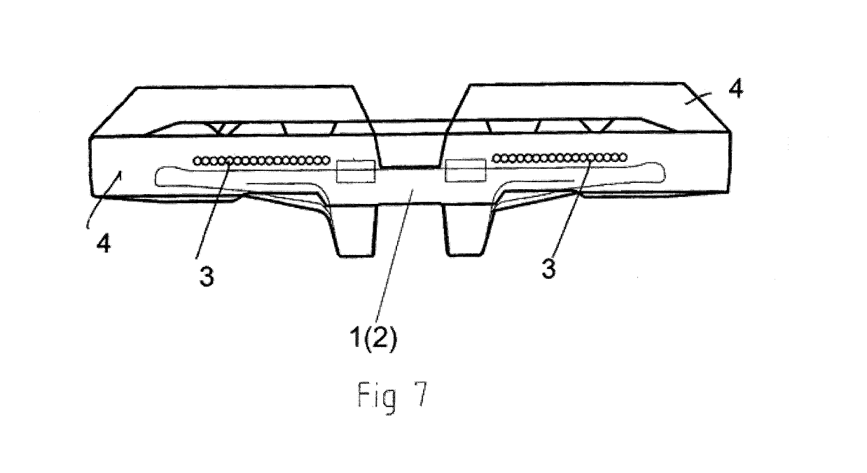

FIG. 7 one element of the track chain, reinforced with steel wires and totally or partly embedded with rubber-like plastic;

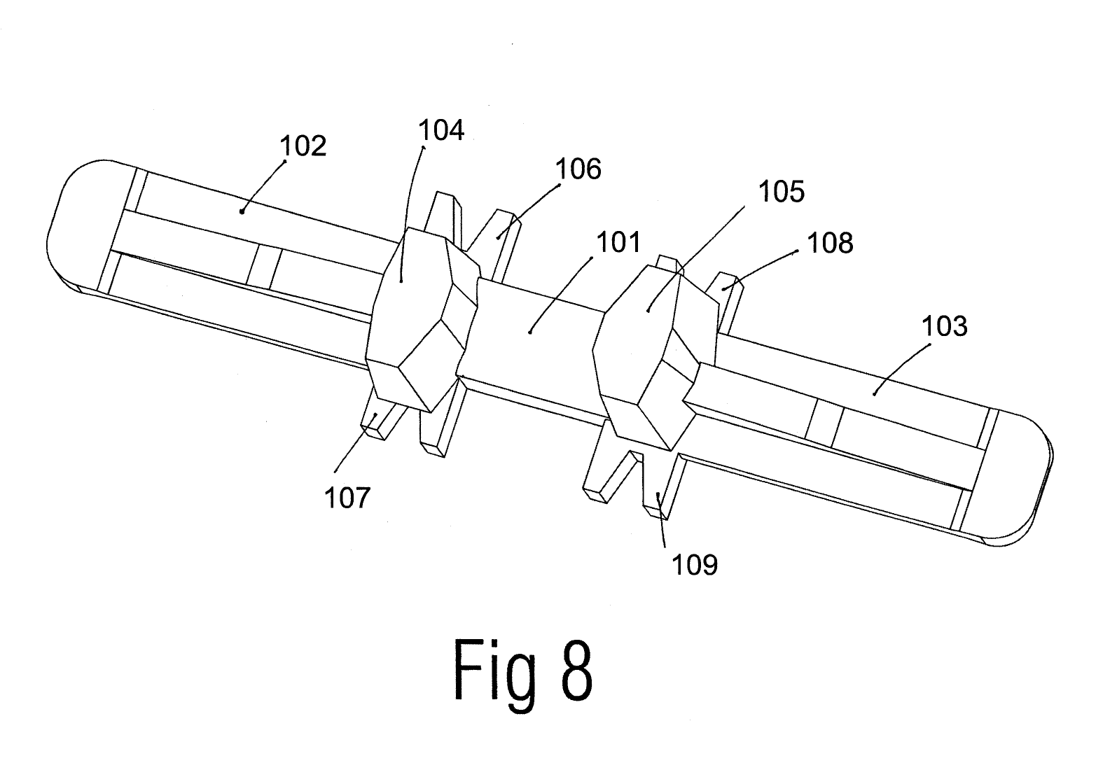

FIG. 8 inner steel core element, shown in FIG. 2 in perspective view;

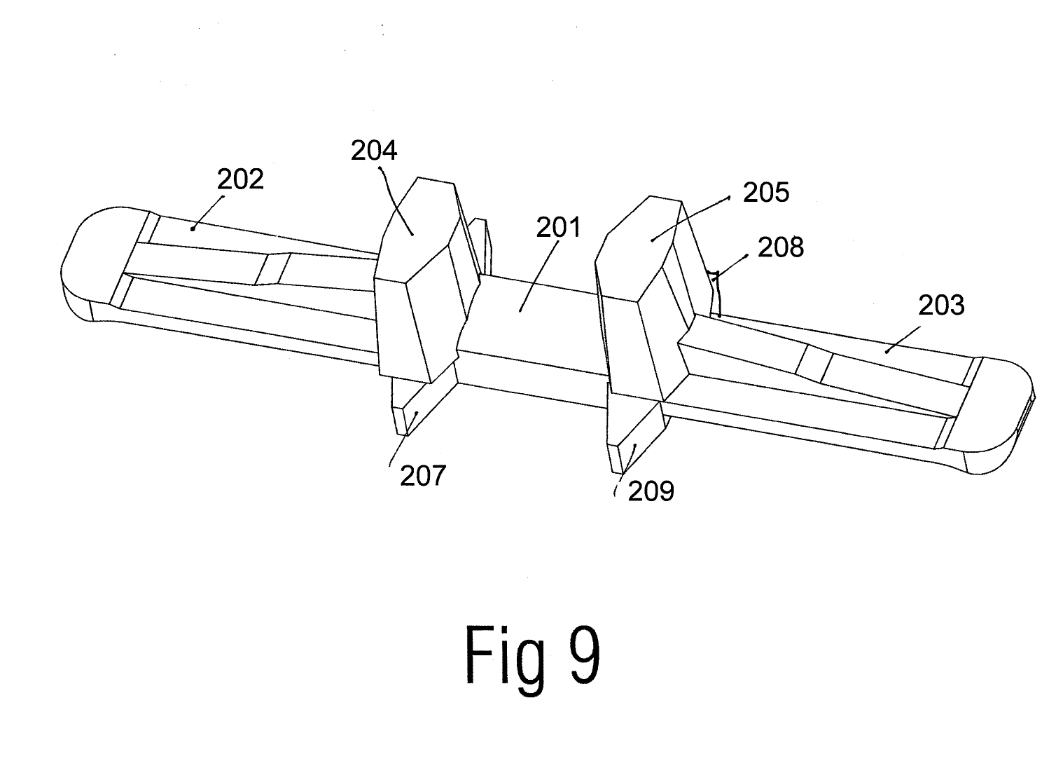

FIG. 9 inner steel core element, shown in FIG. 4 in perspective view;

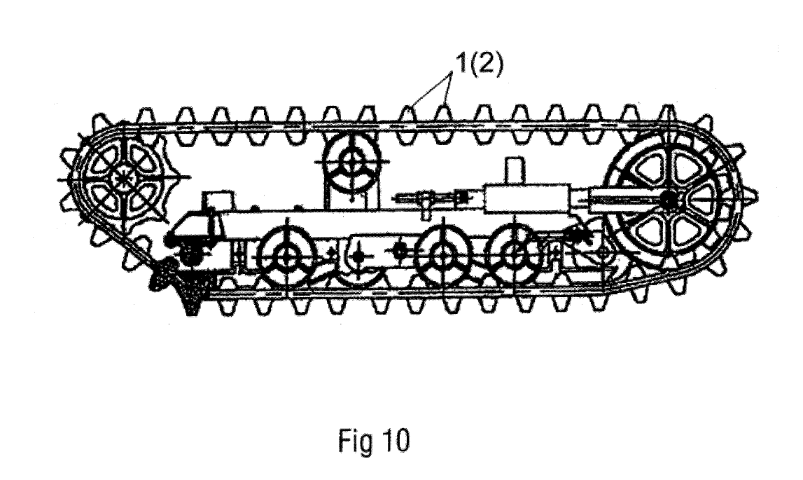

FIG. 10 partly side view of a crawler;

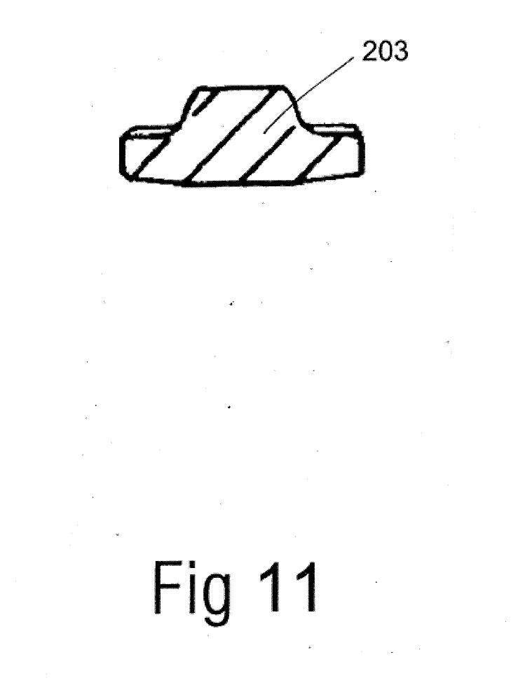

FIG. 11 cross section according to line XI-XI of FIG. 5 and

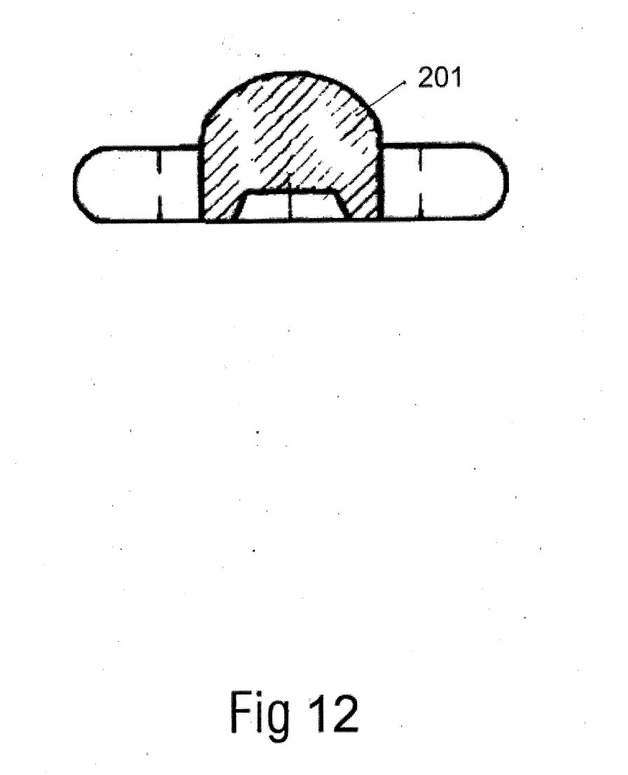

FIG. 12 cross section according to line XII-XII of FIG. 5.

### MODE OF EXECUTION

FIG. 1 shows that this annular inner core is made up by the first iron core 1 and the second iron core 2 that are mutual engagement.

FIGS. 2 and 3 show that there is the first interface 101 with the driving wheels on the first iron core 1, there are the first left wing 102 and the first right wing 103 on the both sides of the first interface with the driving wheels.

There is the arc outer contour surface 1021 on the free end of the first left wing 102, the arc outer contour surface 1031 on the free end of the first right wing 103.

There is the first left top 104 of the iron core between the first interface with the driving wheels and the first left wing 102, there is the first right top 105 of the iron core between the first interface 101 with the driving wheels and the first right wing 103. The first left top 104 of the iron core and the first right top 105 of the iron core are doming on the same side of the first interface 101 with the driving wheels.

There are the first left fork-type buckles on the both sides of the first interface 101 with the driving wheels and perpendicular to the doming direction of the first left top of the iron core 106 and 107.

There are the first right fork-type buckles 108, 109 on the both sides of the first interface with the driving wheels 101 and perpendicular to the doming direction of the first right top of the iron core.

According to FIGS. 4 and 5, there are the second interface 201 with the driving wheels on the second iron core 2, there are the second left wing 202 and the second right wing 203 on the both sides of the second interface with the driving wheels 201. There are the arc outer contour surfaces 2021 under the second left wing 202, the arc outer contour surfaces 2031 under the second right wing 203.

There is the second left top of the iron core 204 between the second interface with the driving wheels 201 and the second left wing 202, there is the second right top of the iron core 205 between the second interface with the driving wheels 201 and the second right wing 203. The second left top of the iron core 204 and the second right top of the iron core 205 are doming on the same side of the second interface with the driving wheels 201.

There are the second left pointed snaps 201 on the both sides of the second interface with the driving wheels 201 and perpendicular to the doming direction of the second left top of the iron core 206 and 207.

There are the second right pointed snaps 205 on the both sides of the second interface with the driving wheels 201 and perpendicular to the doming direction of the second right top of the iron core 208 and 209.

According to FIG. 1, the first left fork-type buckle 107 and the second pointed snap 206 of the first iron core 1 and the second iron core 2 that are arranged by a certain pitch are mutual engagement. The first right fork-type 109 and the second right pointed snap 208 are mutual engagement.

FIG. 6 shows in more detail a part of a track chain with first and second iron cores 1 and 2 totally or partly embedded in rubber like plastic. As can be seen from FIG. 6, there are steel wires or cables marked with reference 3. The steel wires or cables 3 are fixed by plastic or a suitable elastomer with rubber likes characteristics. The steel wires or cables are arranged one by one according to the diameter. The first iron core and the second iron core 1 and 2 got on their left hand wing 102 and the right wing 103 iron teeth, which project right angles to the surfaces of the first and second iron cores 1 and 2. During the production the track is divided in three parts, the elastomer or plastic above, the iron teeth in the middle and the rubber below. In the molding production the plastic or elastomer could be in the iron teeth, keep the steel cables or wires stretched tight and then put the rubber or elastomer above and start vulcanization. So the method to fix the steel cables or wires in the rubber or elastomer track is to keep them stretched tight, they will be fixed in the rubber or elastomer after vulcanization. The rubber or plastic above and below is NR and SBR. Vehicles equipped with such chains may be used in farmer equipment like agricultural power machinery, farmland construction machinery, village machinery, planting and fertilizing machinery, plant protection machinery, agro-processing-machinery, agriculture-transport-machinery, crawl tractors and so on.

The main components of rubber or plastic are

100 phr rubber elastomer (the natural rubber and the synthetic rubber)
40-70 phr supporting material
2-6 phr zinc oxide
5-20 phr plasticizer
1.5-3.0 phr sulfur
1.5-3.0 phr accelerant

The plastic rubber is between 0.5 and 2 mm thick.

The second left wing 202 and the second right wing 203 are embedded in the rubber and plastic. Every two iron teeth is a group. One tooth snaps in the recess of the other.

All the other FIGS. 8, 9, 11 and 12 show in more detail the configuration of the different iron cores, whereas FIG. 10 shows a track according to the invention build in in a crawler for farm working purposes.

The plastic elastomer body is marked with the reference 4.

1. The annular inner core of rubber track is including the compartmental iron cores, the first iron core and the second iron core, the first iron core is including the first interface with the driving wheels, there are the first left wing and the first right wing on the both sides of the first interface with the driving wheels, there is the first left top of the iron core between the first left wing and the first interface with the driving wheels and the first right top of the iron core between the first right wing and the first interface with the driving wheels, the first left and right tops of the iron core are doming with the same side of the first interface with the driving wheels, the second iron core is including the second interface with the driving wheels, there are the second left wing and the second right wing on the both sides of the second interface with the driving wheels, there is the second left top of the iron core between the second left wing and the second interface with the driving wheels and the second right top of the iron core between the second right wing and the second interface with the driving wheels, the second left and right tops of the iron core are doming with the same side of the second interface with the driving wheels, there are the first left fork-type buckles on the both sides of the first interface with the driving wheels and perpendicular to the doming direction of the first left top of the iron core there are the first right fork-type buckles on the both sides of the first interface with the driving wheels, and perpendicular to the doming direction of the first right top of the iron core, there are the second left pointed snaps on the both sides of the second interface with the driving wheels and perpendicular to the doming direction of the second left top of the iron core, there are the second right pointed snaps on the both sides of the second interface with the driving wheels and perpendicular to the doming direction of the second right top of the iron core, the first left fork-type buckle and the second pointed snap of the first iron core and the second iron core that are arranged by a certain pitch are mutual engagement, the first right fork-type and the second right pointed snap are mutual engagement.

2. Track chain according to claim 1, characterized in that the annular inner core of rubber track is that there are the arc outer contour surfaces under the first left wing and the first right wing.

3. Track chain according to claim 1, characterized in that the annular inner core of rubber track is that there are the arc outer contour surfaces under the second left wing and the second right wing.

4. Track chain for chain-driven vehicles such as construction vehicles, agricultural machines, transport vehicles, where the track chain comprises chain links made of a steel alloy and disposed a distance apart in the direction of travel and which on their surfaces coming into contact with the ground to be driven over are embedded either singly or preferably in pairs in a matrix made from elastic plastic or natural rubber (NR) or tyrene-butadiene rubber (SBR), where two adjacent chain links are at right angles to the direction of travel provided with elements set a distance apart and point in the direction of travel and mesh moveably with one another in a plane which lies perpendicular to the direction of travel.

5. Track chain for chain-driven vehicles such as construction vehicles, agricultural machines, transport vehicles, where the track chain comprises chain links made of a steel alloy and disposed a distance apart in the direction of travel and which by their surfaces which come into contact with the ground to be driven over are embedded either singly or preferably in pairs in a matrix made from elastic plastic or natural rubber (NR) or tyrene-butadiene rubber (SBR), where two adjacent chain links are provided with projecting portions which are set a distance apart and point in the direction of travel and which incorporate recesses and the one, adjacent chain link is provided with projecting portions which are set a distance apart and pointing towards the other chain link in the direction of movement of the track chain and engage positively and moveably with clearance with the recesses in the other adjacent chain link.

6. Track chain for chain-driven vehicles such as construction vehicles, agricultural machines, transport vehicles, where the track chain comprises chain links made of a steel alloy and disposed a distance apart in the direction of travel and which by their surfaces which come into contact with the ground to be driven over are embedded either singly or in pairs in a matrix made from elastic plastic or natural rubber (NR) or tyrene-butadiene rubber (SBR), where at right angles to the direction of movement of the respective chain one of two adjacent chain links made from steel is provided with projecting portions which are set a distance apart and point in the direction of movement of the chain and incorporate recesses and the other, adjacent chain link is provided with projecting portions which are set a distance apart and project against the other chain link in the direction of movement of the track chain and engage positively but with clearance with the recesses in the one adjacent chain link, where the recesses and the projecting portions which engage in them are in plan view enclosed by straight side faces.

7. Track chain for chain-driven vehicles such as construction vehicles, agricultural machines, transport vehicles, where the track chain comprises chain links made of a steel alloy and disposed a distance apart in the direction of travel and which by their surfaces coming into contact with the ground to be driven over are embedded either singly or in pairs in a matrix made from elastic plastic or natural rubber (NR) or tyrene-butadiene rubber (SBR), where at right angles to the direction of travel two adjacent chain links incorporate projecting portions with recesses, and the other chain link incorporates projecting portions which engage with the recesses and the projecting portions which engage with the recesses and the recesses in the chain links made from steel are trapezium-shaped.

8. Track chain for chain-driven vehicles such as construction vehicles, agricultural machines, transport vehicles, where the track chain comprises chain links made of a steel alloy and disposed a distance apart in the direction of travel and which by their surfaces coming into contact with the ground to be driven over are embedded either singly or in pairs in a matrix made from elastic plastic or natural rubber (NR) or tyrene-butadiene rubber (SBR), where at right angles to the direction of movement of the respective chain two adjacent chain links are provided with projecting portions with recesses and projecting portions which engage with the recesses, where the recesses and the projecting portions which engage with the recesses are formed triangular in the plan view and the edge areas are rounded off.

9. Track chain according to claim 1, characterised in that the flank angle of the projecting portions and recesses in the chain links which respectively engage with one another is acute-angled and which is not a self-locking angle.

10. Track chain according to claim 1, characterised in that the side faces of the projecting portions and of the two recesses of the steel chain links which lie against each one are formed curved and roll over each other when the track chain moves.

11. Track chain according to claim 1, characterised in that the matrix which is made of plastic is made of an elastomer plastic which is resistant to water, oil and petrol which are encountered in practical operation and is also designed to be ozone-resistant and light-fast.

12. Track chain according to claim 1, characterised in that the matrix which is made of plastic is made of a natural rubber (NR) or a styrene-butadiene rubber (SBR) having the required Shore hardness and resilience and is stable at a temperature of from minus 50° C. to plus 70° C., when it is made of NR or minus 40° C. to plus 80° C. if it is made of SBR.

13. Track chain according to claim 1, characterised in that the matrix which is made of plastic is made of polyurethane plastic or polyamide plastic having the required Shore hardness and resilience.

14. Track chain according to claim 1, characterised in that the matrix which is made of plastic is reinforced with wires which are made preferably of steel and completely enclosed in plastic and are set a distance apart and extend in the direction of travel of the chain.

15. Track chain according to claim 1, characterised in that the matrix also encloses the chain links which are made of steel at their sides.

16. Track chain according to claim 1, characterised in that between the projecting portions and the recesses on adjacent chain links which engage with one other a gap is disposed with which each of the teeth of any motor-driven gear wheels used on the respective track-laying vehicle engage.

17. Track chain according to claim 1, characterised in that the chain links which are made of steel are provided with single-piece projecting portions disposed at their end portions and arranged at right angles to them which projecting portions engage in the plastic matrix and connect the matrix to the respective chain link in a single piece.

18. Track chain according to claim 1, characterised in that the chain links are made of a steel having a bending strength F≧35 KN.

19. Track chain according to claim 1, characterised in that the chain links which are made of steel are manufactured in a single piece by drop-forging.

20. Track chain according to claim 1, characterised in that the chain links made of steel are manufactured in a single piece by the cast steel method.

21. Track chain according to claim 1, characterised in that the chain links which are made of steel are provided on their side pointing towards the respective gear wheel over which they are guided, with projecting portions which are formed materially in a single piece and which are set a distance part and on each of which projecting portions offset 90 degrees and pointing in the direction of travel and incorporating recesses or projecting portions are provided.

22. Track chain according to claim 1, characterised in that the projecting portions receiving the teeth of the gear wheel between them are provided on their outer side with ribs which are formed materially in single piece and decrease in height at a constant angle to the end of the respective chain link into the free portions of the respective chain link made of steel and taper down to about the surface of the respective steel chain link.

23. Track chain according to claim 1, characterised in that several, preferably two chain links which are arranged close to each other are reinforced by steel wires which are positioned side-by-side symmetrically to both sides of the chain link and which are embedded in the matrix made of an elastomere, whereby the steel wires are arranged on the outer side of the chain link which is faced to the floor and whereby the longitudinal axes of the steel wires are parallel to the movement of the track chain.

24. Chain link for construction of a track chain for chain-driven vehicles in accordance with claim 1, characterised in that the chain link consists of a flat member which is rectangular in plan view and on which in the direction of movement of the chain projecting portions are disposed on both sides of the longer sides of the chain link each of which projecting portions incorporates open recesses or projecting portions facing in the direction of movement of the chain.

25. Chain link for construction of a track chain for chain-driven vehicles in accordance with claim 1, characterised in that the chain link consists of a flat element which is rectangular in plan view and on which in the direction of movement of the chain, that is, on diametrically opposed sides of the longer sides of the chain link, are disposed projecting portions each of which incorporates recesses which are open in the direction of movement of the track.

26. Chain link in accordance with claim 24, characterised in that in plan view the one chain link incorporates a rectangular element in the middle longitudinal section of which two material accumulations are provided which are set a distance apart and each of which incorporates on opposite sides and in pairs two projecting portions which project at right angles to each longer side of the respective chain link and are set a distance apart and which between them enclose a preferably trapezium-shaped space, where in plan view the projecting portions are themselves approximately trapezium-shaped, and that material accumulations are provided offset 90 degrees from these projecting portions disposed in pairs a distance apart on each longer side of the chain link each of which material accumulations consists of two parts which are in plan view approximately rectangular and point towards each other by their longer base sides and the edge portions of which are bevelled.

27. Chain link in accordance with claim 24, characterised in that in plan view the other chain link is rectangular-shaped and incorporates in the middle longitudinal portion two material accumulations which are set a distance apart and which consist in plan view of two approximately trapezium-shaped portions which are formed materially in a single piece and which point towards each other and the upper edge areas of which are broken or rounded, where projecting portions offset 90 degrees from these material accumulations are provided on each longer side of the respective chain link and form a single piece with the chain link and in plan view are approximately trapezium-shaped.

28. Chain-driven vehicles such as construction vehicles, agricultural machines, or transport vehicles with tracks in accordance with claim 1 which are driven via gear wheels.

29. Track chain according to claim 4, characterised in that the flank angle of the projecting portions and recesses in the chain links which respectively engage with one another is acute-angled and which is not a self-locking angle.

30. Track chain according to claim 4, characterised in that the matrix which is made of plastic is made of an elastomer plastic which is resistant to water, oil and petrol which are encountered in practical operation and is also designed to be ozone-resistant and light-fast.

31. Track chain according to claim 1, characterised in that the matrix which is made of plastic is made of a natural rubber (NR) or a styrene-butadiene rubber (SBR) having the required Shore hardness and resilience and is stable at a temperature of from minus 50° C. to plus 70° C., when it is made of NR or minus 40° C. to plus 80° C. if it is made of SBR.

32. Track chain according to claim 4, characterised in that the matrix which is made of plastic is made of polyurethane plastic or polyamide plastic having the required Shore hardness and resilience.

33. Track chain according to claim 4, characterised in that the matrix which is made of plastic is reinforced with wires which are made preferably of steel and completely enclosed in plastic and are set a distance apart and extend in the direction of travel of the chain.

34. Track chain according to claim 4, characterised in that between the projecting portions and the recesses on adjacent chain links which engage with one other a gap is disposed with which each of the teeth of any motor-driven gear wheels used on the respective track-laying vehicle engage.

35. Track chain according to claim 4, characterised in that the chain links which are made of steel are provided with single-piece projecting portions disposed at their end portions and arranged at right angles to them which projecting portions engage in the plastic matrix and connect the matrix to the respective chain link in a single piece.

36. Track chain according to claim 4, characterised in that the chain links are made of a steel having a bending strength F≧35 KN.

37. Track chain according to claim 4, characterised in that the chain links which are made of steel are manufactured in a single piece by drop-forging.

38. Track chain according to claim 4, characterised in that the chain links made of steel are manufactured in a single piece by the cast steel method.

39. Track chain according to claim 4, characterised in that the chain links which are made of steel are provided on their side pointing towards the respective gear wheel over which they are guided, with projecting portions which are formed materially in a single piece and which are set a distance part and on each of which projecting portions offset 90 degrees and pointing in the direction of travel and incorporating recesses or projecting portions are provided.

40. Track chain according to claim 4, characterised in that the projecting portions receiving the teeth of the gear wheel between them are provided on their outer side with ribs which are formed materially in single piece and decrease in height at a constant angle to the end of the respective chain link into the free portions of the respective chain link made of steel and taper down to about the surface of the respective steel chain link.

41. Track chain according to claim 4, characterised in that several, preferably two chain links which are arranged close to each other are reinforced by steel wires which are positioned side-by-side symmetrically to both sides of the chain link and which are embedded in the matrix made of an elastomere, whereby the steel wires are arranged on the outer side of the chain link which is faced to the floor and whereby the longitudinal axes of the steel wires are parallel to the movement of the track chain.

42. Track chain according to claim 5, characterised in that the flank angle of the projecting portions and recesses in the chain links which respectively engage with one another is acute-angled and which is not a self-locking angle.

43. Track chain according to claim 5, characterised in that the matrix which is made of plastic is made of a natural rubber (NR) or a styrene-butadiene rubber (SBR) having the required Shore hardness and resilience and is stable at a temperature of from minus 50° C. to plus 70° C., when it is made of NR or minus 40° C. to plus 80° C. if it is made of SBR.

44. Track chain according to claim 5, characterised in that the matrix which is made of plastic is made of polyurethane plastic or polyamide plastic having the required Shore hardness and resilience.

45. Track chain according to claim 5, characterised in that the matrix which is made of plastic is reinforced with wires which are made preferably of steel and completely enclosed in plastic and are set a distance apart and extend in the direction of travel of the chain.

46. Track chain according to claim 5, characterised in that between the projecting portions and the recesses on adjacent chain links which engage with one other a gap is disposed with which each of the teeth of any motor-driven gear wheels used on the respective track-laying vehicle engage.

47. Track chain according to claim 5, characterised in that the chain links which are made of steel are provided with single-piece projecting portions disposed at their end portions and arranged at right angles to them which projecting portions engage in the plastic matrix and connect the matrix to the respective chain link in a single piece.

48. Track chain according to claim 5, characterised in that the chain links are made of a steel having a bending strength F≧35 KN.

49. Track chain according to claim 5, characterised in that the chain links which are made of steel are manufactured in a single piece by drop-forging.

50. Track chain according to claim 5, characterised in that the chain links made of steel are manufactured in a single piece by the cast steel method.

51. Track chain according to claim 5, characterised in that the chain links which are made of steel are provided on their side pointing towards the respective gear wheel over which they are guided, with projecting portions which are formed materially in a single piece and which are set a distance part and on each of which projecting portions offset 90 degrees and pointing in the direction of travel and incorporating recesses or projecting portions are provided.

52. Track chain according to claim 5, characterised in that the projecting portions receiving the teeth of the gear wheel between them are provided on their outer side with ribs which are formed materially in single piece and decrease in height at a constant angle to the end of the respective chain link into the free portions of the respective chain link made of steel and taper down to about the surface of the respective steel chain link.

53. Track chain according to claim 5, characterised in that several, preferably two chain links which are arranged close to each other are reinforced by steel wires which are positioned side-by-side symmetrically to both sides of the chain link and which are embedded in the matrix made of an elastomere, whereby the steel wires are arranged on the outer side of the chain link which is faced to the floor and whereby the longitudinal axes of the steel wires are parallel to the movement of the track chain.

54. Chain link for construction of a track chain for chain-driven vehicles in accordance with claim 5, characterised in that the chain link consists of a flat element which is rectangular in plan view and on which in the direction of movement of the chain, that is, on diametrically opposed sides of the longer sides of the chain link, are disposed projecting portions each of which incorporates recesses which are open in the direction of movement of the track.
